(19) United States
(12) Patent Application Publication
(10) Pub. No.: US 2023/0051975 A1
(43) Pub. Date: Feb. 16, 2023

(54) SYSTEM, METHOD, AND APPARATUS FOR IDENTIFYING CAUSES OF IMBALANCES IN FACILITY OPERATIONS

(71) Applicant: Validere Technologies Inc., Toronto (CA)

(72) Inventors: Ian Bruce BURGESS, Toronto (CA); Daniel FUSCA, Toronto (CA); Mikhail ASKERKA, Toronto (CA); Adam William WEINSTEIN, Toronto (CA)

(73) Assignee: Validere Technologies Inc., Toronto (CA)

(21) Appl. No.: 17/887,895

(22) Filed: Aug. 15, 2022

Related U.S. Application Data
(60) Provisional application No. 63/232,860, filed on Aug. 13, 2021.

(30) Foreign Application Priority Data
Aug. 13, 2021 (CA) 3128117

(51) Int. Cl. G05B 23/02

(52) U.S. Cl. CPC G05B 23/0272; G05B 2223/02

(57) ABSTRACT

A method for identifying imbalances in facility operations. The method includes determining an existence of an imbalance between a first volume of a component at a first point in the facility and a second volume of the component at a second point in the facility, calculating a probability likelihood of the imbalance being caused by one or more likely errors of a set of known likely errors, determining an impact magnitude on the imbalance of each of the one or more likely errors, and assigning an importance ranking to each of the one or more likely errors based on the probability likelihood and the impact magnitude.

### BACKGROUND

In petroleum operations, a “balance” typically refers to the difference in component volumes between two points of a facility such as a plant or the like (e.g., receipts vs. dispositions). In an ideal scenario, outgoing component volumes would be equal to incoming component volumes, resulting in a balance of zero. However, due to various factors such as operational losses, metering differences, measurement error, compositional differences, and so forth, component volumes often differ between two points of the facility. This results in a non-zero balance, or imbalance. In general, a tight balance (i.e., a small difference in component volumes) is desired; a tight balance implies that product is not being lost or gained during plant operations and that producers are being paid appropriately for their product. While a specific desired balance may be subjective and may depend on a particular plant and its goals, it is generally considered that balances closer to zero are more desirable.

Having a proper balance can create value for a facility with respect to a number of factors. As a non-limiting example, having a proper balance can facilitate: preventing overpayment for upstream product; enabling better auditing of downstream counterparties (i.e., ensuring proper payments to the client); better allocation of flash losses & loss allowance recoveries at terminals; creating strong audit trails of operations, resulting in less time spent in audits; mitigating risk of disputes and/or decreasing time spent in disputes; increasing efficiency and effectiveness of full time employees (e.g., operations, engineering, measurement, production accounting); reduction of licensing on data management software, if applicable; and so forth.

However, proper balancing can be difficult to implement. Measurement and sampling errors can introduce significant amounts of uncertainty. Insufficient collection of data can also complicate reconciling component volumes entering a facility with component volumes exiting the facility. Moreover, physical volume losses, metering errors, inaccurate data, and various other causes can introduce inaccuracies in balancing. Balancing thus tends to be an exercise in isolating errors and attempting to determine and focus on the data that is most representative of actual operations.

When an imbalance that is outside desired parameters occurs, the root cause of the imbalance must be found and rectified. However, known methods of determining such root causes typically involve sequentially diagnosing the causes from a list of known causes until the actual cause is found. Such methods are slow and inefficient and frequently result in new issues developing before existing issues can be solved. An improved method for identifying causes of imbalances in facility operations is therefore desired.

### SUMMARY

According to at least one exemplary embodiment, a method for identifying imbalances in facility operations is disclosed. The method includes determining an existence of an imbalance between a first volume of a component at a first point in the facility and a second volume of the component at a second point in the facility, calculating a probability likelihood of the imbalance being caused by one or more likely errors of a set of known likely errors, determining an impact magnitude on the imbalance of each of the one or more likely errors, and assigning an importance ranking to each of the one or more likely errors based on the probability likelihood and the impact magnitude.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary balancing report for a facility.

FIG. 2 shows an exemplary balancing report for a component.

FIG. 3 shows an exemplary output of a balancer.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

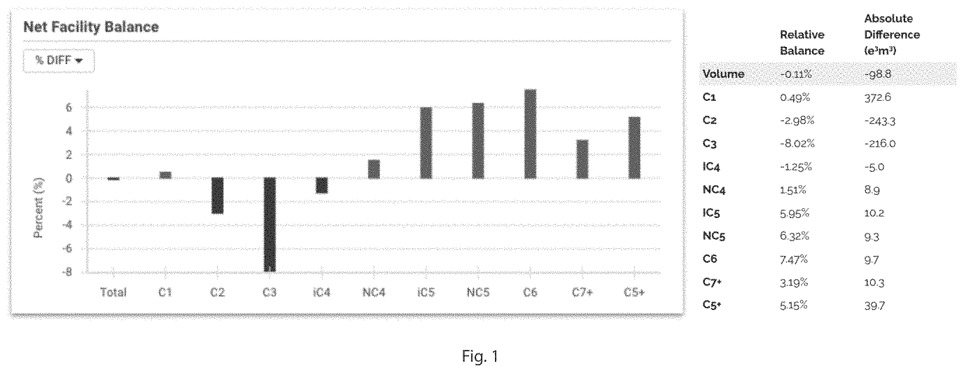

According to at least one exemplary embodiment, a method, system, and apparatus for identifying imbalances in plant operations is disclosed (referred to subsequently herein as a “balancer”). FIG. 1 shows an exemplary balance report for a facility. While the exemplary balance report shows a net facility balance, it should be appreciated that such a report may be shown for any two points in the facility. The exemplary balance report may show a net balance for each desired component, as well as an absolute difference (for example in thousands of cubic meters, or e3m3) in the volumes of each desired component. In the exemplary balance report, it may be seen that a tight balance (within ±5%) exists for most components, while the C3 component has the greatest disbalance, with an −8% difference.

Generally, a balance is a calculation of the difference between component volumes at two points in a facility. Of particular interest may be the receipts-to-disposition balance, often referred to as the net balance. The net balance is a measurement of the amount of volume that was gained or lost on a component as the component left the producer and was sold by the facility. However, the embodiments disclosed herein can consider the balance between any two points in a facility. To perform a balance calculation, the gross difference and the balance may be calculated for each component of interest and for the total volume. As used herein, “upstream” refers to a stream or group of streams further upstream to the point that is being used for comparison, while “downstream” refers to a stream or group of streams further downstream from the point being used for comparison. To calculate the gross difference, upstream volume is subtracted from downstream volume, resulting in an absolute volume difference between the two points of comparison. The balance equation is (downstream volume)/(upstream volume)−1, which results in a relative difference between two points of comparison.

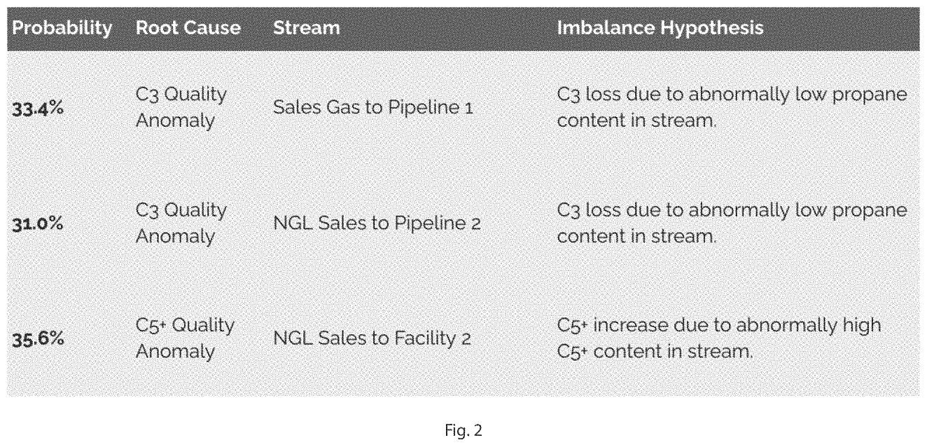

FIG. 2 shows an exemplary balancing report for the C3 component, as may be generated by the embodiments disclosed herein. The exemplary balancing report can provide a listing of one or more likely root causes for a particular imbalance. For each root cause, the balancing report can further identify a particular component stream wherein the imbalance may be found, provide a hypothesis for the imbalance, and provide a probability likelihood of each proposed root cause being the actual root cause for the imbalance.

According to some exemplary embodiments, the balancer may use one or more facility data sources to estimate a likelihood of different types of errors that may lead to a particular imbalance. The facility data sources can include historical facility data as well as any other data that enables the balancer to function as described herein.

Historical facility data may be used, for example, to calculate the probabilities of an imbalance due to sampling errors. For example, if a recent sample has deviated from historical data, and adjusting the measurement of the deviated sample back to historical norms would lead to a tighter balance, the balancer may flag such sample as potentially erroneous and a potential source of imbalance. Other data sources can include, but are not limited to: high-resolution volume measurements from the facility; estimates of emission factors for plant equipment so as to estimate imbalances due to fugitive emissions; data from vapor recovery units so as to estimate volume imbalances due to flash (evaporation) of volatile hydrocarbons from crude oil; and the like.

Errors considered by the balancer can include, but are not limited to, metering irregularities (volume), sampling errors (quality), data transmission errors (typically volume), and operational irregularities (e.g., flash loss, leaks, facility upset, and so forth). The types of errors considered by the balancer can include, but are not limited to, “no flow” volume errors, “repeated value” volume errors, “natural” volume errors, “natural” sample errors, and so forth. For example, “no flow” and “repeated value” errors are incorrect volume measurements that may result from faulty transmissions of remote flow meters. The no-flow error occurs when a flow meter fails to send data, while the repeated value error occurs when a meter sends an incorrect repeated value for the flow (as, typically, flow data is not constant). “Natural” volume errors may be incorrect volume measurements resulting from the natural limits on the inaccuracy of volume measurement instruments. For example, sometimes an imbalance may be accounted for by a natural measurement error of a particularly high-volume stream. “Natural” sample errors are incorrect measurements of a product's chemical composition that may arise from natural limits on sample accuracy. Operational issues such as flash loss and leak loss may cause a plant imbalance if the hydrocarbons that leave the system via evaporation (i.e., flash) or via leaking equipment (i.e., fugitive emissions) are not accounted for.

The balancer may also consider sample errors that stem from improper sampling technique, errors in data entry, and so on. The balancer may consider any type of error that would result in a sample differing significantly from the historical norm of samples for the stream in question. Based on the data sources, the balancer can then prioritize errors that both have a high probability of occurrence and a high impact on the particular imbalance.

To determine the impact magnitude, for each error type, the balancer may adjust a related set of values in the Record of Quality (“RoQ”). A Record of Quality may be a table summarizing the volume and chemical composition of the products flowing through a list of streams over a period of time. In an exemplary embodiment, each row of the table may correspond to a stream. For any given row, the column entries can be the volume, percent methane (c1), percent ethane (c2), as well as any additional desired data, of the product that passed through the associated stream. The balancer can then place such RoQ data into a matrix x₀. The i, j^{th} entry of the RoQ matrix is the value of measurement j for stream i. The balancer can then assume that each source of imbalance affects the RoQ in a known way. Consequently, each hypothetical error may then be compensated for by adjusting the RoQ. If the resulting new RoQ is more tightly balanced, it is taken as a strong indicator that the error is a significant source of imbalance; i.e., that the impact of the error on the imbalance is significant.

To accomplish the adjustment, the balancer may determine a specific magnitude for the adjustment. The magnitude of the adjustment is determined by considering the amount of total facility imbalance that is lowered by the adjustment and constraining the magnitude such that the result of the adjustment remains within a range of plausible variations.

According to at least one exemplary embodiment, the adjustment may be performed by utilizing a function B=x₀+av, wherein B is the balance amount, x₀ is the initial RoQ data, a is the magnitude of the adjustment, and v is an error vector that encodes which RoQ values to vary. In other words, formally, the adjustments to the given RoQ xo are achieved by adding a term av, resulting in a new, hypothetical RoQ x₀+av, where the error under consideration is accounted for. Here, a is a scalar representing the magnitude of the adjustment (or “shift”). The variable v is a matrix with the same shape as x₀. The matrix may also be referred to as a vector. The vector v determines which entries of the RoQ are modified by the adjustment.

The vector v can be a matrix with the same shape as the RoQ matrix x₀. The sum x₀+av can represent the initial RoQ, with each entry (x₀)ᵢⱼ being shifted by avᵢⱼ. For example, to shift the value of measurement j in stream i, and leave everything else unchanged, v may be chosen to have every entry equal to zero except for the i, j^{th} entry.

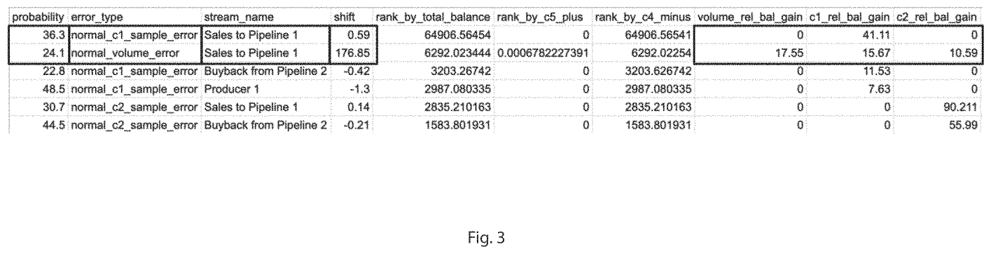

FIG. 3 shows an exemplary table of RoQ values x₀, an exemplary table of vector and adjustment products, and an exemplary table of balance results. Each row in the table can represent a different stream. The columns of the table represent the total volume of hydrocarbons that passed through that stream over a month. The total volume is broken down by hydrocarbon; in the example of FIG. 3—methane (c1) to hexanes and heavier molecules (c6+).

For an RoQ x with shape M×N (i.e., M streams with signed volume measurements for N hydrocarbons), Bal(x) is a vector of length N computed by summing the rows of x. This is the net loss or gain in volume of each hydrocarbon. The x₀ values may be shifted by the vector av values, and, if the shifted x₀=av values (i.e., the resulting B values) are well-balanced, the particular error associated with v may be regarded as a likely cause of the imbalance.

The magnitude of adjustment a may be chosen such that x₀+av is closer to being balanced than xo, based on an assumption that an ideal facility is balanced. However, the magnitude of adjustment a may also be constrained to a “reasonable” value, based on a probability distribution of the set of possible adjustments a.

The magnitude of adjustment a may be chosen based on a cost function. The cost function may be a weighted average of the initial balance |B(x₀)| and the balance of the shifted data |B(x₀+av)|:

L(a):=P(|A|<|a|)·|B(x₀)|²+P(|A|>|a|)·|B(x₀+av)|²

To lower the cost, xo may be shifted in a direction that lowers the balance, such that |B(x₀+av)| is reduced. However, if the magnitude of adjustment a is so large that it is unlikely to find a larger error, the relative contribution of |B(x₀+av)| may be decreased. Consequently, the magnitude of adjustment is determined such that lowers the total plant imbalance while remaining plausible.

As the impact of a source of imbalance on the RoQ is encoded by the vector v and the scalar a, where v encodes which entries in the RoQ are affected by the error source (and in what proportion), and a encodes the magnitude of the shift. The vector v is determined by the type of error in consideration. The magnitude a is given a probability distribution to define how plausible a shift is. Thus, the balancer can consider a large set of sources of imbalance, each with their characteristic vector v, and each with a distribution of possible shift magnitudes a. The role of the cost function is to simplify the analysis by identifying, for each error, a single adjustment magnitude a that strikes a good compromise between being impactful on the plant's balance and being plausible. The user may then read a single adjustment, with a single probability and a single impact on the balance, rather than a whole distribution of adjustments and impacts.

The above calculations may be performed for each possible cause of error for a particular imbalance of the facility. Once a plurality of possible errors is determined, the errors may be assigned an “importance” ranking. As used herein, the importance ranking for an error may be calculated based on a probability of the error and an impact of the error on the balance. Thus, higher probabilities and higher impacts will result in a higher importance ranking. The importance ranking may be calculated according to:

I:=P(error)·|Balance(xᵢₙᵢₜᵢₐₗ)−Balance(xₑᵣᵣₒᵣ)|²

If only the effect of an error on a subset of the component balance is of interest, the importance ranking may be computed in the same manner, but with only the relevant component balances being included in the |Balance(xᵢₙᵢₜᵢₐₗ)−Balance(xₑᵣᵣₒᵣ)|² term.

The strategy is to fit a probability distribution to historical data of a particular P measurement. The statistical models that may be used and the data that may be used to fit the models can depend on the type of measurement in question. Regardless of how the historical model is obtained, it is used as a distribution on the true or idealized value M of the currently observed measurement m*.

Formally, the probability that M lies in a region R is given by P(M∈R)=∫_{R}π(m)dm, where π is the probability density function derived from historical measurements. This distribution is used to estimate the probability of a given shift magnitude a by computing a probability of error with magnitude at least a=P(|M−m*|>|a|). That is, the probability of the error in question shifting the RoQ by an amount a is taken to be the probability that the true measurement M differs from the observed measurement m* by an amount greater than |a|. The notation A=M−m* may be used to represent the “true adjustment”, i.e., the adjustment necessary to bring the observed value to the true value.

FIG. 3 shows an exemplary balancer output, including an error ranking result for all components, for C5 only, and for C4 only. The balancer output may be interpreted, for example, as follows. In the first row of the output, shifting the C1 quality measurement appearing on the RoQ by 0.59% may result in an improvement in the C1 imbalance across the facility by 41.11%. Furthermore, the probability that the true C1 quality is at least 0.59% greater than the current RoQ is 36.3%. Similarly, in the second row of the output, shifting the total volume appearing on the RoQ by adding 176.85 e3m3 may result in an improvement in the total volume balance by 17.55%, in the C1 balance by 15.67%, and in the C2 balance by 10.59%. Furthermore, the probability that the true total volume is at least 176.85 e3m3 greater than the current RoQ is 24.1%.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for identifying imbalances in facility operations, comprising:
determining an existence of an imbalance between a first volume of a component at a first point in the facility and a second volume of the component at a second point in the facility;
calculating a probability likelihood of the imbalance being caused by one or more likely errors of a set of known likely errors;
determining an impact magnitude on the imbalance of each of the one or more likely errors; and
assigning an importance ranking to each of the one or more likely errors based on the probability likelihood and the impact magnitude.

2. The method of claim 1, further comprising displaying a ranked list of the one or more likely errors.

3. The method of claim 1, wherein the first point in the facility is upstream of the second point in the facility.

4. The method of claim 1, wherein facility data sources are used to calculate the probability likelihood of the imbalance.

5. The method of claim 4, wherein the facility data sources comprise historical facility data.

6. The method of claim 4, wherein the facility data sources comprise one or more of volume measurements from the facility, estimates of emission factors, and vapor recovery unit data.

7. The method of claim 1, wherein the known likely errors include one or more of metering irregularities, sampling errors, data transmission errors, data entry errors, operational irregularities, no-flow volume errors, repeated value volume errors, natural volume errors, and natural sample errors.

8. The method of claim 1, wherein determining an impact magnitude includes adjusting a related set of values in a record of quality.

9. The method of claim 1, wherein the impact magnitude is adjusted based on a cost function.

10. The method of claim 1, wherein the impact magnitude is determined based on a probability distribution of a set of possible adjustments.
